(19) United States
(12) Patent Application Publication
(10) Pub. No.: US 2013/0233794 A1
(43) Pub. Date: Sep. 12, 2013

(54) METHOD FOR TREATING WASTEWATER WITH BACTERIA-LOADED LIGNOCELLUOSIC MATERIAL

(71) Applicant: Walter Lawrence Brown, Raleigh, NC (US)

(72) Inventor: Walter Lawrence Brown, Raleigh, NC (US)

(21) Appl. No.: 13/417,316

(22) Filed: Mar. 11, 2012

(51) Int. Cl. C02F 3/02

(52) U.S. Cl. 210/616; 210/198.1

(57) ABSTRACT

A method for treating wastewater through the use of powdered natural lignocellulosic materials (PNLM) and/or powdered kenaf (PK). The method includes mixing particulate kenaf with microorganisms to form an effector composition, mixing the effector composition with influent wastewater, oxygenating the wastewater, reacting the wastewater and clarifying the wastewater, resulting in improvement in the microbial population effector composition in the wastewater.

### CROSS-REFERENCE TO RELATED APPLICATIONS

The present invention is related to one or more prior-filed co-pending patent applications and claims priority therefrom; it claims the benefit of U.S. patent application Ser. No. 12/775,861 which is incorporated herein by reference in its entirety. The present invention also claims the benefit of U.S. patent application Ser. No. 13/105,486, which claims benefit from US Provisional Patent Application serial no. 61/333,928 filed May 12, 2010, both of which are incorporated herein by reference in their entirety.

### BACKGROUND OF THE INVENTION

1. Field of the Invention

The present invention relates to the treatment of wastewater, and particularly, municipal and/or industrial wastewaters.

2. Description of the Prior Art

The treatment of contaminated wastewater from municipal, industrial or CAFO sources involves a sequence of processing steps for maximizing water purification at minimum costs. Industrial effluents, particularly wastewater from oil refineries and chemical factories, include a broad spectrum of contaminants, and, consequently, such wastewater is usually more difficult to decontaminate than wastewater from municipal sewage systems. Four main sequential process treatments are used to decontaminate such industrial effluents although similar treatment is given municipal effluents, or combined municipal/industrial effluents. These are primary, intermediate, secondary, and tertiary treatments. The primary treatment calls for removal of gross amounts of oil and grease and solids from the wastewater. In municipal and CAFO wastewater treatment, generally little free oil is present but solids removal is still needed. The intermediate treatment is the next process and it is designed to adjust water conditions so that the water entering the secondary treatment zone will not impair the operation of the secondary treatment processes. In other words, intermediate treatment is designed to optimize water conditions so that the secondary treatment process will operate most efficiently. The secondary treatment calls for biologically degrading dissolved organics and ammonia in the water. One of the most common biological treatment processes employed is the activated sludge process discussed below in greater detail. The tertiary treatment calls for removing residual biological solids present in the effluent from the secondary treatment zone and further removing trace contaminants which contribute to impairing water clarity or adversely affecting water taste and odor. This is usually a filtration of the water, preferably through beds of sand, or combinations of sand and coal, followed by treatment with activated carbon.

The activated sludge process is a conventional wastewater treating process which produces a high degree of biological treatment in a reasonably compact format. The application of this process to the treatment of industrial and CAFO wastewater has, however, been relatively slow compared with municipal applications. Industrial applications of this process are nevertheless increasing rapidly. Currently, the activated sludge process is capable of reliably achieving about 85% to 98% reduction in the five-day biochemical oxygen demand (BOD.sub.5). However, the BOD.sub.5 contaminants present in industrial wastewater are typically small compared with the total oxygen demanding contaminants present in such wastewater as measured by the chemical oxygen demand (COD) test. For example, the BOD.sub.5 contaminants present in the effluent from an activated sludge process typically ranges from 2 to 20 parts per million parts of water. It is not uncommon to also find present in such effluent 10 to 20 times this amount of COD.

The activated sludge process generally has at least two, but preferably four stages of treatment. In the first stage, contaminated water is contacted with the activated sludge. The sludge includes microorganisms which feed on the contaminants in the water and metabolize those contaminants to form cellular structure and intermediate products. This decontaminated water flows into a second clarifier stage where suspended sludge particles are separated from the decontaminated water. A portion of the sludge is recycled to the first stage and the remainder can be forwarded to the third and fourth stages as is taught in Grutsch et al., U.S. Pat. Nos. 4,073,722 and 4,292,176. This sludge forwarded to the third and fourth stages includes water. In the third stage the sludge is thickened to remove excess water and in the fourth stage the thickened sludge is permitted to digest, that is, the microorganisms feed upon their own cellular structure and are stabilized. The digestion step stabilizes the microorganisms. U.S. Pat. No. 4,073,722 teaches dewatering, thickening, and digestion of activated sludge and powdered activated carbon mixtures.

Activated carbon is often used in tertiary treatment as a final cleanup for water discharged from the second stage clarifier. Some have taught that activated carbon, fine carbon (e.g., powdered anthracite) or fine particle clays such as bentonite and Fuller's earth can be used to treat wastewater in a biological treatment process. U.S. Pat. No. 3,904,518 teaches that between about 50 and 1500 parts of activated carbon or between about 250 and 2500 parts of adsorptive bentonite or Fuller's earth per million parts of feed wastewater can be beneficial in water purification. The carbon or Fuller's earth has a surface area of at least 100 square meters per gram and the activated carbon will typically have a surface area of between 600-1400 square meters per gram.

While a variety of powdered inorganic adsorbent materials have been used in biological treatment systems, powdered activated carbon remains the material most commonly used. Several mechanisms have been suggested as to how these materials enhance the treatment of wastewater: improved buffering; increased biological surface area for key organisms such as nitrifying bacteria that favor attached growth; decreased system sensitivity to toxic substances; improved phase separation, and adsorption. Adsorption is most important when the system is operated at low solids retention times (SRT)—namely, before particles are colonized by attached growth bacteria and other microorganisms. Thus, as particle surface area becomes less accessible, the role of adsorption decreases and the other mechanisms dominate.

The relatively high cost of activated carbon has served as a strong deterrent to common use of the material in activated sludge treatment of municipal, industrial and CAFO wastewaters. One approach to reducing cost of activated carbon has been recovery, regeneration and recycling of the activated carbon. This is best illustrated in the appropriately labeled Powdered Activated Carbon Treatment (PACT™) system disclosed in U.S. Pat. Nos. 3,904,518 and 4,069,148, by Hutton et al. The PACT™ treatment system operates as a continuous flow process with an aeration basin followed by a discrete clarifier to separate biologically active solids and carbon from the treated wastewater. The recovered, regenerated powdered activated carbon is then returned to the aeration basin along with a portion of the recovered sludge.

Rehm and coworkers have further refined the use of activated carbon in the aerobic oxidation of phenolic materials by using microorganisms immobilized on granular carbon as a porous biomass support system. Utilizing the propensity of microorganisms to grow on and remain attached to a surface, Rehm used a granular activated carbon support of high surface area (1300 m.sup.2/g) to which cells were attached within the macropores of the support and on its surface, as a porous biomass support system in a loop reactor for phenol removal. H. M. Ehrhardt and H. J. Rehm, Appl. Microbiol. Biotechnol., 21, 32-6 (1985). The resulting “immobilized” cells exhibited phenol tolerance up to a level in the feed of about 15 g/L, whereas free cells showed a tolerance not more than 1.5 g/L. It was postulated that the activated carbon operated like a “buffer and depot” in protecting the immobilized microorganisms by adsorbing toxic phenol concentrations and setting low quantities of the adsorbed phenol free for gradual biodegradation. This work was somewhat refined using a mixed culture immobilized on activated carbon [A. Morsen and H. J. Rehm, Appl. Microbiol. Biotechnol., 26, 283-8 (1987)] where the investigators noted that a considerable amount of microorganisms had “grown out” into the aqueous medium, i.e., there was substantial sludge formation in their system.

Suidan and coworkers have done considerable research on the analogous anaerobic degradation of phenol using a packed bed of microorganisms attached to granular carbon [Y. T. Wang, M. T. Suidan and B. E. Rittman, Journal Water Pollut. Control Fed., 58 227-33 (1986)]. For example, using granular activated carbon of 16 times 20 mesh as a support medium for microorganisms in an expanded bed configuration, and with feed containing from 358-1432 mg phenol/L, effluent phenol levels of about 0.06 mg/L (60 ppb) were obtained at a hydraulic residence time (HRT) of about 24 hours. Somewhat later, a beri-saddle-packed bed and expanded bed granular activated carbon anaerobic reactor in series were used to show a high conversion of COD to methane, virtually all of which occurred in the expanded bed reactor; P. Fox, M. T. Suidan, and J. T. Pfeffer, ibid., 60, 86-92 (1988). The refractory nature of ortho- and meta-cresols toward degradation also was noted.

The impregnation of flexible polymeric foams with activated carbon is known to increase the ability of fabrics and garments to resist the passage of noxious chemicals and gases see for example, U.S. Pat. Nos. 4,045,609 and 4,046,939. However, these patents do not teach the use of these foams in wastewater treatment, or that these foams are a superior immobilization support for the growth and activity of microorganisms.

Givens and Sack, 42nd Purdue University Industrial Waste Conference Proceedings, pp. 93-102 (1987), performed an extensive evaluation of a carbon impregnated polyurethane foam as a microbial support system for the aerobic removal of pollutants, including phenol. Porous polyurethane foam internally impregnated with activated carbon and having microorganisms attached externally was used in an activated sludge reactor, analogous to the Captor and Linpor processes which differ only in the absence of foam-entrapped carbon. The process was attended by substantial sludge formation and without any beneficial effect of carbon.

The Captor process itself utilizes porous polyurethane foam pads to provide a large external surface for microbial growth in an aeration tank for biological wastewater treatment. The work described above is the Captor process modified by the presence of carbon entrapped within the foam. A two-year pilot plant evaluation of the Captor process itself showed substantial sludge formation with significantly lower microbial density than had been claimed. J. A. Heidman, R. C. Brenner and H. J. Shah, J. of Environmental Engineering, 114, 1077-96 (1988). A point to be noted, as will be revisited below, is that the Captor process is essentially an aerated sludge reactor where the pads are retained in an aeration tank by screens in the effluent line. Excess sludge needs to be continually removed by removing a portion of the pads via a conveyor and passing the pads through pressure rollers to squeeze out the solids.

In U.S. Pat. No. 6,395,522 DeFilippini and coworkers describe a biologically active support system for providing removal of pollutants such as aliphatics, aromatics, heteroaromatics and halogenated derivatives from waste streams. The support contains a particulate adsorbent such as activated carbon bound by a polymer binder to a substrate such as a polymeric foam, and a bound pollutant-degrading microorganism. They claim that the biologically active support can be used in conventional aerobic biological waste treatment systems such as continuous stirred reactors, fixed-bed reactors and fluidized bed reactors.

H. Bettmann and H. J. Rehm, Appl. Microbial. Biotechnol., 22, 389-393 (1985) have employed a fluidized bed bioreactor for the successful continuous aerobic degradation of phenol at a hydraulic residence time of about 15 hours using Pseudomonas putida entrapped in a polyacrylamide-hydrazide gel. The use of microorganisms entrapped within polyurethane foams in aerobic oxidation of phenol in shake flasks also has been reported; A. M. Anselmo et al., Biotechnology B. L., 7, 889-894 (1985).

Known bioremediation processes suffer from a number of inherent disadvantages. For example, a major result of increased use of such processes is an ever increasing quantity of sludge, which presents a serious disposal problem because of increasingly restrictive policies on dumping or spreading untreated sludge on land and at sea. G. Michael Alsop and Richard A. Conroy, “Improved Thermal Sludge Conditioning by Treatment With Acids and Bases”, Journal WPCF, Vol. 54, No. 2 (1982), T. Calcutt and R. Frost, “Sludge Processing—Chances for Tomorrow”, Journal of the Institute of Water Pollution Control, Vol. 86, No. 2 (1987) and “The Municipal Waste Landfill Crisis and A Response of New Technology”, Prepared by United States Building Corporation, P.O. Box 49704, Los Angles, Calif. 90049 (Nov. 22, 1988). The cost of sludge disposal today may be several fold greater than the sum of other operating costs of wastewater treatment.

A slightly different biophysical treatment process is described by McShane et al., in “Biophysical Treatment of Landfill Leachate Containing Organic Compounds”, Proceedings of Industrial Waste Conference, 1986 (Pub. 1987), 41st, 167-77. In this process a biological batch reactor is used with powdered activated carbon and the system is operated in the “fill and draw” mode, also known as the sequenced batch reactor (SBR) mode. A similar scheme for treatment of leachate is disclosed in U.S. Pat. No. 4,623,464 by Ying et al. in which an SBR is operated with both biologically active solids and carbon present to treat a highly toxic PCB and dioxin-containing leachate. Supplementation with powdered activated carbon has been successfully demonstrated to improve treatment of widely differing wastewater streams in all such variations of the activated sludge process. Use of powdered activated carbon in this manner remains, nevertheless, rare—particularly in treatment of municipal wastewaters where cost factors are paramount. Most wastewater treatment plant owners and treatment plant managers and system operators deem the cost of doing so to be excessive.

U.S. Pat. No. 7,481,934 by Skillicorn, relates to the present invention, and is invented and owned by a common entity; while this patent provides relevant prior art, the present invention provides additional beneficial treatment of wastewater—notably enhanced reduction of wasted activated sludge volatile solids—at or proximal to the digester stage of the process, which is a surprising discovery as an alternative to treating the waste stream at other points in the process as described and taught in said patent.

US Pub. No. 20110011780—System for improving total water qualities in eutrophicated and contaminated water area utilizing water purifying functions of various plants and microorganisms, published Jan. 20, 2011 for Yumin Izumo. Describes a system for improving the total water qualities in an eutrophicated and contaminated water area utilizes the water purifying functions of various plants and microorganisms. The system takes the form of a floating inland with plants, which have functions of absorbing eutrophication components from the roots and thus purifying water. The system also contains an anchor for fixing the floating island to the bottom, a weight for controlling the floating conditions of the floating island, and a connecting member for connecting the floating island, the anchor and the weight together. An aquatic plant or an aerobic or anaerobic microorganism capable of absorbing eutrophication components is stuck to at least the lower part of the system in a manner suitable for the environmental conditions of the contaminated water area, thereby achieving an effect of improving the water qualities simultaneously at all of the water face, the under water part and the bottom. Kenaf (Hibiscus cannabinus) can act as purification plants and can absorb nitrogen and phosphorus.

U.S. Pat. No. 7,481,934 & US Pub. No. 20070170115—Methods for treatment of wastewater with powdered natural lignocellulosic material; inventor: Skillicorn;. Assignee: Renewable Fibers, LLC. Teaches a process for biologically treating wastewater that uses bacteria to denitrify incoming wastewater with kenaf powder as an energy source for the microorganisms. Further describes that the kenaf powder acts as a filter to efficiently separate out solids from the incoming wastewater and aid in settling of biosolids. Also describes that the kenaf powder adsorbs hazardous materials present in the wastewater.

U.S. Pat. No. 6,436,288—Bast medium biological reactor treatment system for remediation and odor suppression of organic waste streams. Assignee: Mississippi State University. Teaches a biological wastewater treatment system that uses bacteria to denitrify incoming wastewater using kenaf bast and core fibers as an energy source for the microorganisms. Further describes that the kenaf fibers act as a filter to separate out solids from the incoming wastewater. It appears to also describe that the kenaf fibers act to trap odors.

U.S. Pat. No. 6,620,611 & US Pub. No. 20020090697—Solid-chemical composition for sustained release of organic substrates and complex inorganic phosphates for bioremediation. Teaches a slow-release chemical composition for environmental remediation that contains kenaf as an organic substrate. Further describes that kenaf may be used as an energy source, such as for Pseudomonas spp. and other denitrifying bacteria. It appears to also describe that the composition can be used for in-situ treatment of environmental contamination, including various types of contaminated water, including sewage and other wastewater.

US Pub. No. 20020148780—Method of enhancing biological activated sludge treatment of waste water, and a fuel product resulting therefrom. Teaches the use of kenaf as an energy source to improve biologically mediated denitrification of wastewater, such that there is no need to add additional nutrients to promote bacterial growth and survival. Further describes that kenaf is used to absorb hazardous materials present in the wastewater. It appears to also include that the kenaf contains a carbohydrate that increases the settling rate of biosolids in the wastewater.

### SUMMARY OF THE INVENTION

The present invention relates to the treatment of municipal wastewater through the use of microorganisms absorbed onto lignocellulosic particulate.

It is an object of this invention to provide an effector composition that includes lignocellulosic particles, most preferably kenaf particles, with at least one absorbed microorganism species for the purpose of treating wastewater treatment process that is generally applicable to treatment of municipal waste streams at a reactor stage.

Another object of this invention is to provide systems and methods having an enhanced reactor process that significantly reduces the greenhouse gas emissions of the reactor process.

Yet another object of this invention is to provide systems and methods having an enhanced microbial circumstance that significantly enhances the floccing and/or settling characteristics of a method for treating wastewater mixed liquor; thus increasing the speed and efficiency of sludge settling, enhancing the speed and efficiency of clarified supernatant decanting and therefore increasing the total material throughput capacity of those reactors and clarifiers. by providing an effector composition that includes kenaf particles with at least one absorbed microorganism species.

Accordingly, a broad embodiment of this invention is directed to a method for processing kenaf particles loaded with bacteria for the purpose of treating wastewater using a lignocellulosic particulate, the method steps including: mixing lignocellulosic particles into the wastewater and/or wastewater mixed liquor; oxygenation the wastewater; reacting the wastewater; and clarifying the wastewater.

Still another aspect of the present invention is to provide systems and methods having mixing of lignocellulosic materials (LCM) with wastewater and/or wastewater mixed liquor that transforms the wastewater and/or wastewater mixed liquor having a first alkalinity to an increased alkaline stage, preferably with at least 50% increase of the first alkalinity.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a graph of the effluent TSS prior to treatment (Eff TSS 10-11) and during treatment (Eff TSS 11-12).

FIG. 2 is a graph of the ammonia content in the effluent prior to treatment (Eff NH 310-11) and during treatment (Eff NH3 11-12).

FIG. 3 is a graph of the sludge yield prior to treatment (Eff MBK 10-11) and during treatment (Eff MBK 11-12).

FIG. 4 is a graph of the phosphorus content of the effluent prior to treatment (Eff P 310-11) and during treatment (Eff P 11-12).

FIG. 5 is a graph of the dissolved oxygen (DO) in the effluent prior to treatment (do 10-11) and during treatment (do 11-12).

FIG. 6 is a graph of the NO3 in the effluent prior to treatment (Eff N 10-11) and during treatment (Eff N 11-12).

FIG. 7 is a graph of the Aeration Alkalinity and effluent Nitrogen prior to treatment and during treatment, the start of treatment denoted in the figure.

FIG. 8 is a graph of the Aeration Alkalinity prior to treatment (A Alk 10-11) and during treatment (A Alk 11-12).

FIG. 9 is a graph of the FISH results for Example 1 (Mebane).

FIG. 10 is a graph of the FISH results for Example 2 (Lenoir).

FIG. 11 is a graph of the MLSS for Example 3 (Roanoke).

FIG. 12 is a graph of the FISH results for Example 3 (Roanoke).

FIG. 13 is a graph of the particle numbers per ml of effluent before and after treatment.

FIG. 14 is a graph of the particle sizes in the effluent before and after treatment.

### DETAILED DESCRIPTION

Referring now to the drawings in general, the illustrations are for the purpose of describing a preferred embodiment of the invention and are not intended to limit the invention thereto. The figures illustrate changes in processes following implementation of the systems and methods of the present invention, namely graphs and charts of key performance indicators of the reactors for wastewater treatment. U.S. Pat. No. 7481934 and US Application Publication No. 20090170747, US Application Publication No. 20080206836, each of which are incorporated herein by reference in their entirety.

### DEFINITIONS

Lignocellulosic—any plant material; plants, including trees, grasses etc., are made up of lignin and cellulose.

SND—Simultaneous Nitrification and Denitrification

AOB—Ammonia Oxidizing Bacteria

NOB—Nitrite Oxidizing Bacteria

Annamox—Ammonium/Ammonia Oxidizing Bacteria

FISH—Fluorescent In situ Hybridization

BNR—Biological Nutrient Removal

The present invention provides an effector composition that includes a lignocellulosic particle with at least one absorbed microorganism species for treating wastewater. In the present invention, an effector composition is an entity having the ability to effect a change on the wastewater.

The present invention uses a lignocellulosic media with at least one absorbed microorganism to upgrade an existing activated sludge system, converting it to an activated sludge biofilm reactor system. This enhancement provides treatment and operational efficiencies, including improved microbial populations, and more efficient nitrification and denitrification.

The present invention claims priority from US Pub. 20110272350, which is incorporated herein by reference in its entirety, for Methods for treatment of waste activated sludge, published Nov. 10, 2011 for Paul Skillicorn and David Yates; it describes a process for treating waste primary or activated sludge solids that have been removed to a digester phase of the activated sludge process through the use of powdered natural lignocellulosic materials (PNLM) and/or powdered kenaf core (PKC). These materials help this process by: (a) thickening of primary and/or waste activated sludge through adsorption, attached growth and achieving closer proximity of organisms by stimulating reduction of their associated ECP substance; (b) enhancing endogenous reduction of primary and/or waste activated sludge by thickening (see above) and improving the ratio of available carbon to available nitrogen by delivering a continuing gradual release of sugar from degrading PNLM and/or PKC; (c) enhancing the speed of endogenous reduction of primary and/or waste activated sludge--through higher efficiencies (same processes as above); and (d) improving dewatering characteristics of wasted primary and/or wasted activated sludge solids (through reduction and breakdown of ECP materials and higher densification of solids).

Also, the present invention claims priority from 20110281321, which is incorporated herein by reference in its entirety, for Microbial remediation system and method, published Nov. 17, 2011 for Paul Skillicorn; it describes methods and systems for effecting an environmental change by providing an effector composition that includes lignocellulosic particles with at least one absorbed microorganism species, wherein the lignocellulosic particles are preferably kenaf particles. The method steps include mixing at least one microorganism species with kenaf particles to form an effector composition and then dispersing the effector composition in the environment.

Over the years, there has been study and debate about floc, discussion of flocculent-based nitrification and denitrification, often referred to as SND, Simultaneous Nitrification and Denitrification. The key difference here is this is SND in a Biofilm Reactor situation leveraging the attributes of a lignocellulosic biofilm media to promote Autotrophic growth and present a constant floc-based source of usable carbon as part of the mixed liquor. For simplicity, the following are assumed: stable MLSS, adequate/stable alkalinity, good mixing, good carbon to nitrogen ratios, and good dissolved oxygen (DO) control.

The present invention is advantageous through increased denitrification of the wastewater. The present invention modifies and enhances two rate limiters in an activated sludge system—bacterial population and bacterial proximity to more efficiently remove nitrogenous compounds from the waste effluent or wastewater.

Bacterial Population—The amount of Ammonia a system can nitrify is limited to the system's population of autotrophic nitrifiers. As a review, Ammonia/Ammonium is nitrified by autotrophs, Ammonia Oxidizing Bacteria, AOBs, and Nitrite Oxidizing Bacteria, NOBs. These work together to form Nitrate, NO3. By increasing the population of nitrifiers as a percentage of an activated sludge population then the option to follow one shared treatment path and two separate treatment paths is created.

### The Shared Treatment Path:

Removal of COD and Ammonia with less oxygen. With more nitrifiers, one has the potential to convert ammonia using less oxygen. Due to a larger population, the nitrifiers are more efficient at “hunting and gathering”/collecting and processing the DO that the nitrifiers need. Also, beneficially, not as much DO is lost to the atmosphere or used up, or consumed, by competitive Heterotrophs. Thus, a lower DO to achieve nitrification and then the facultative heterotrophs “reuse” the O2 that they get from the Nitrate that has been converted by the nitrifiers from ammonia.

With systems and methods of the present invention, at least two Path options are provided for transforming the wastewater with lignocellulosic material to (purified) effluent suitable for discharge into the environment under US Regulations at the time of the present invention.

### Path One:

With more nitrifiers, the potential to convert more ammonia load in the same reactor space and time exists. Alternatively, Path Two: With more nitrifiers, the potential to convert the same ammonia load in less reactor space and time exists.

Bacterial proximity—To nitrify and denitrify, autotrophs and facultative heterotrophs need access to oxygen, nitrate and carbon. Autotrophic biofilms populate the lignocellulosic media and then these populations become “pioneers/settlers”, branching out and populating surrounding floc. This progression is visible under a phase contrast microscope and track the colonization via DNA FISH analysis. The increases in autotrophic populations are not limited to the lignocellulosic media-based floc, autotrophs use the media as an initial colonizing structure and then expand to the rest of the activated sludge.

### Proximity to Nutrients:

Ammonia. As with the population logic set forth hereinabove, since systems and methods of the present invention provide for more nitrifiers as a whole the nitrifiers are closer in proximity to the Ammonia in the bulk liquid making the Ammonia pick up more efficient.

### Proximity to Dissolved Oxygen (DO):

Also as noted above, with a larger population of nitrifiers populating the media-based floc and non-media-based floc according to the systems and methods of the present invention, the “workers” (bacteria, preferably selected from the group consisting of AOB, NOB, etc., and combinations thereof) are in closer proximity to the DO in the bulk liquid making the uptake of DO more efficient.

### Proximity to Each Other:

nitrifiers. With more nitrifiers as part of the floc, the hand off transactions from the AOBs to the NOBs are more efficient. This is evidenced dramatically in the Figures showing the pictures DNA fish analysis showing both nitrifiers as part of a populated floc.

Proximity to “De-Nitrifiers”:

with more nitrifiers forming nitrate at the floc level there is nitrate more closely available in physical proximity to facultative heterotrophs, microbes that consume or “breathe nitrate”, in and around the floc. Advantageously, using the systems and methods of the present invention, this transaction becomes more efficient, due to the lignocellulosic material additive to the wastewater and transformation of the alkalinity of and/or oxygen available in the wastewater for bacterial processing for treatment thereof.

### Proximity to Carbon for Denitrification:

the lignocellulosic media, (being made up of lignin which has a COD of 1.85 mg/mg and cellulose with a COD of 1.185 mg/mg,) is ultimately covered by biofilms and diffused layers of complimentary microbes. This biofilm forms anoxic and anaerobic areas in the media-based floc and thicker non media based floc. Lignin and cellulose break down in low oxygen environments releasing back to carbon. This carbon source is at the floc level, readily available to facultative heterotrophs to use during the denitrification transaction.

The advantages conferred by increasing bacterial population and bacterial proximity are enhanced with the present invention. Premixing a lignocellulosic material to an activated sludge with the appropriate bacteria and adding the mixture to a wastewater reactor reactor increases the bacterial population and immediately establishes the proper bacteria in the proximity of the lignocellulosic material. These advantages provided by the present invention increase the efficiency of the reactor and thus increase the loading capacity of the reactor.

With improvements in AOB populations and efficiencies due to their growth on a lignocellulosic media, AOBs convert Ammonia to Nitrite, significant increases in Annamox bacteria populations are a result. The lignocellulosic media enhances the growth and stability of Annamox by making Nitrite more readily available.

Annamox bacteria use NH3 and NH4 plus Nitrate, converting the Ammonia straight to nitrogen, reduce the greenhouse gas emissions, and water. This is a very efficient circumstance, there is no oxygen (02) needed for the NOB conversion to Nitrate and there is no carbon necessary. In addition, since there is no carbon consumed, the sludge yield of the transaction is nominal, whereas the sludge yield for a heterotrophic bacteria converting Nitrate facultatively is generally assumed to create 0.85 sludge yield for COD of carbon consumed.

A method according to the present invention includes the following steps: adding lignocellulose particulate to wastewater; oxygenating the wastewater, reacting the wastewater, and clarifying the wastewater.

The bacteria are preferably autotrophic nitrifiers, including ammonia oxidizing bacteria(AOBs) and nitrite oxidizing bacteria (NOBs) and Annamox. Ammonia (NH3) is removed biologically from wastewater streams via two pathways. Both path ways require AOBs, AOBS oxidize NH3 to NO2 Nitrite. There is a fork in the road here. One fork takes the Nitrite and oxidizies it to Nitrate, NO3 via Nitrite Oxidizing Bacteria—then the NO3 is consumed by facultative Heterotrophic bacteria and is realeased as N2. The second Nitrite fork follows the Annamox path. Annamox bacteria consumes NO2 and NH3 and releases N2. That is how we get rid of Ammonia in wastewater biologically. It is call Biological Nutrient Removal BNR.

The lignocellulose particulate and bacteria are preferably mixed as the lignocellulosic media is slurried prior to delivery into the wastewater reactor's mixed liquor. Bacteria come in liquid states and freezed dried states. Mixing is based on concentration of the bacterial mix.

The method further includes the step of adding the lignocellulose particulate to the wastewater at a rate determined by surface area based on biofilm loading rates, SRTs, and media degradation factors needed to convert a mg of influent to remove Ammonia. A surface area flux rate of 0.1225 for a media with 7.4 square meters of surface area per gram is the base line for loading. The surface area is key for the attached growth and colonization of bacteria.

The method may further include the steps of enhancing Alkalinity conditions during the Autotrophic growing and acclimation period and the control of oxygenating the wastewater to keep the dissolved oxygen high enough to encourage nitrification. The growth cycle typically takes between 90 and 120 days to establish the improved level of Autotrophic (AOB, NOB and Annamox) microbes.

The lignocellulose particulate preferably has a specific surface area above about 5 square meters per gram and a COD value above about 0.8 mg/mg. More preferably, the lignocellulose particulate has a specific surface area of about 7.4 square meters per gram and a COD value of 1.17 mg. Even more preferably, the particulate is powdered Kenaf. In a preferred embodiment, the lignocellulosic particles consist substantially of kenaf particles.

A further step of absorbing the at least one microorganism species into internal spaces of the lignocellulosic particles may be included in the methods of the present invention in addition to the foregoing steps.

In an example embodiment, the lignocellulosic particles are mixed with settled clarifier floc in the return activated sludge well and the mixture is then returned to the reactor. The mixing can be done continuously, once a day, every other day, as long as the particle application is matched with wasting rates, the particles are?

Thus, a method for treating wastewater includes the following steps: mixing water with a lignocellulosic particulate and microbes to form an effector composition; mixing the effector composition with the wastewater; oxygenating the wastewater; reacting the wastewater; clarifying the wastewater; thereby increasing the rate limiting Autotrophic Microbes (AOBs, NOBS, Annamox) and thus helping reducing the carbon, phosphorous and nitrogenous compounds in the wastewater biologically

In the foregoing methods, preferably, the lignocellulosic particles include kenaf particles, and more preferably, the lignocellulosic particles consist substantially of kenaf particles. Importantly, lignocellulosic particles provides both structure and surface area for growth to the bacteria, facilitating the delivery and growth of the bacteria at the floc level target .

The lignocellulosic particle is preferably a powdered natural lignocellulosic material and can consist of sphagnum moss, hemp hurd, jute stick, balsa wood, other hard and soft woods, kenaf core, crop straws, grass specie stems, bamboo specie stems, reed stalks, peanut shells, coconut husks, pecan shells, other shells, rice husk, other grain husks, corn stover, other grain stalks, cotton stalk, sugar cane bagasse, conifer and hardwood barks, corn cobs, and combinations thereof.

As set forth hereinabove, preferably, the particle is powdered kenaf. Beneficially, the kenaf has a porous structure and large specific surface area which will accommodate more microorganisms, Bacterial, algal and/or fungal agents will attach to kenaf core whether in aqueous, moist or completely dry circumstances. Thus, a wide range of bacterial, algal and/or fungal agents can be accommodated in, on and within small-to-medium-sized particles of kenaf and delivered by that mechanism to select targeted application.

Clarification—The present invention provides for better clarification, reduced settling time, increased settling capacity of existing settling basins, and reduced need for flocculent materials. The present invention achieves better clarification of treated wastewater because the lignocelluloses particles provide a substrate for the formation of flocculent. The formation of flocculent reduces or eliminates the need for the addition of flocculation-promoting chemicals, thus reducing or eliminating expense. Furthermore, in testing it has been shown that wastewater treated according to the present invention provided better clarification than control-treated wastewater, thus reducing digester capacity requirements.

Reduced phosphorous—The present invention is also advantageous through the reduction of additives for the elimination of phosphorous from the wastewater. Heretofore, operators needed to add alum to wastewater to sequester the phosphorous in the sludge.

Reduced nitrogen—The present invention advantageously reduces the need for additives for the elimination of nitrogenous compounds from the wastewater. Heretofore, operators needed to add carbon sources such as glycerin to wastewater to promote the removal of the nitrogen compounds from the wastewater.

Reduced oxygenation—Another way the present invention is advantageous is through reduced requirement for dissolved oxygen, which reduces the oxygenation requirements and thus the energy requirements of the treatment process.

Greenhouse gases—Yet another way the present invention is advantageous is through the reduction of greenhouse gases. By adding a lignocellulosic media to activated sludge mixed liquor, lower nitrous oxide emissions can be lowered by promoting larger populations of AOBs, NOBs and Annamox Bacteria as a percent of the Mixed Liquor Suspended Solids (MLSS). More AOBs, NOBs, and Annamox allow the plant to be run at lower average Dissolved Oxygen levels while more efficiently removing the same nutrient loads. The reduction of N2O is an important goal because the global warming potential of N2O is 296 kg equivalent CO2.

“Upon subjecting the nationwide data set to multivariate regression data mining, high nitrite, ammonium, and dissolved oxygen concentrations were positively correlated with N2O emissions from aerobic zones of activated sludge reactors. On the other hand, high nitrite and dissolved oxygen concentrations were positively correlated with N2O emissions from anoxic zones. Based on these results, it can be argued that activated sludge processes that minimize transient or permanent build up of ammonium or nitrite, especially in the presence of dissolved oxygen, are expected to have low N2O emissions.”http://pubs.acs.org/doi/abs/10.1021/es903845y By increasing the population of AOBs, NOBs, and Annamox as a percent of the populations, the presence of more A.N.A. and lower DO significantly reduce the Green House Gas emission of N2O.

By adding a lignocellulosic media to activated sludge mixed liquor we can reduce the amount of CO2 that is created to remove/reduce influent COD. By following the normal oxygen pathway (the DO pathway), oxygen is pumped in, makes its way to the surface and is released into the atmosphere, unused. Oxygen is used by Facultative Heterotrophs to directly convert COD. They “breath” the oxygen, convert the COD mass to their bodies and exhale CO2 at a rate of 1:1. Oxygen is used by AOBs to convert Ammonia to Nitrite, NO2. NOBs use oxygen to convert the Nitrite to Nitrate, NO3 (Nitrification). NO3 is used by Facultative heterotrophs to convert COD. They “breath” the NO3, convert the COD to body mass and exhale CO2 at a rate of “1:.8”.

By making a system more efficient at nitrification—moving ammonia to nitrate—done by having more AOBs, and NOBs available as a percentage of the mixed liquor population the oxygen pathway can be adjusted to look more like below. The oxygen bound to the NO3 is used to reduce COD during the Denitrification phase, the same oxygen unit performs two jobs. Less oxygen is needed less CO2 is produced. Oxygen is pumped in and releases into the atmosphere, unused. Oxygen is used by AOBs to convert Ammonia to Nitrite, NO2. NOBs use oxygen to convert the Nitrite to Nitrate, NO3. NO3 is used by Facultative heterotrophs to convert COD. They “breath” the NO3, convert the COD to body mass and exhale CO2 at a rate of “1:.8”. Oxygen is used by Facultative Heterotrophs to directly convert COD. They “breath” the oxygen, convert the COD mass to their bodies and exhale CO2 at a rate of 1:1. By making a system more efficient at Nitrification—moving Ammonia to Nitrate—done by having more AOBs and NOBs available as a percentage of the mixed liquor population, there is more opportunity to use the oxygen “twice”, once to Nitrify and once to Denitrify. Less oxygen means less CO2.

By adding a lignocellulosic media to activated sludge mixed liquor systems that are using an external carbon source we can significantly reduce the CO2 emissions from a wastewater treatment plant. Due to nature, and the non biofilm situation in most activated sludge reactors, systems have to run DO levels “high” to provide enough 02 to “force” Nitrification via their limited and spread out populations of AOBs and NOBs. By pumping in this “high” DO, systems provide lots of “easy to get to” DO for the Heterotrophs to convert COD, they out-compete the AOBs. This often ends up “burning off” COD at the aerobic end of the process leaving no COD for Denitrification at the anoxic end. So, systems wind up adding an external carbon source for Denitrification because Nitrification is so weak. By improving the Nitrification of Ammonia by Nitrifiers, (AOBs and NOBs) due to a higher population and closer proximity than normal, Nitrifiers become better competitors for available DO. Systems can run lower levels of DO, allowing them to not “burn off” as much COD during Nitrification leaving COD for Denitrification in the anoxic zones.

This efficiency does three things: 1) Lower average DO levels saves power to run pumps; 2) It allows the “double use” of O2, see above change in the O2 pathway via Nitrification and Denitrification; 3) It reduces the amount of external carbon that has to be added into a system. This external carbon is partially converted to CO2 during denitrification.

Additionally, the following reduction in global warming gas emissions result from the present invention: carbon is confined into the bodies of facultative heterotrophs; carbon consumption is reduced due to lower uses of electricity; and carbon consumption is reduced due to reduced use of chemical.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

More Beneficial Autotrophic Microbes—The present invention provides formfor more beneficial Autotrophic microbes. In BNR (Biological Nutrient Removal) or activated sludge wastewater treatment plants, the microbes (the biology) do all the work. In a non-biofilm reactor the naturally occurring level of Autotrophic microbes is limited. By providing a biofilm media/surface area tofor these Autotrophs to attached to and grow upon we improve the living conditions for the Autotrophs and they increase as a percentage of the total microbial population and the entire microbial population becomes more efficient at removing nutrients from the wastewater stream. By adding a surface area media with AOBs, NOBs, or Annamox bacteria already present, you give the system a jump start biologically and a foundation to keep building upon.

Clarification—The present invention provides for better clarification of wastewater, reduction in particulates, reduced settling time, increased settling capacity of existing settling basins, and reduced need for flocculent materials. The present invention achieves better clarification of treated wastewater because the lignocelluloses particles provide a substrate for the formation of large and dense floc that has been kick started by having key microbes seeded prior to application into a reactor. The formation of dense floc reduces or eliminates the need for the addition of flocculation-promoting chemicals, thus reducing or eliminating expense. Furthermore, in testing it has been shown that wastewater treated according to the present invention provided better clarification and particulate removal than control-treated wastewater, thus reducing clarifier capacity requirements or increasing flow rates of existing clarification circumstances along with helping post filter systems say cleaners longer.

Reduced phosphorous—The present invention is also advantageous through the reduction of additives for the elimination of phosphorous from the wastewater. Heretofore, operators needed to add alum or other chemicals to wastewater to sequester the phosphorous in the sludge, this is referred to as CPR—Chemical Phosphorous Removal

Reduced phosphorous via BPR—The present invention is also advantageous through the release of needed VFAs (Volitile Fatty Acids) via Lignin and Cellulose breakdown in the reactors. VFAs are a key component in the BPR process, this breakdown can enable systems to remove phosphorous biologically as opposed to chemically. With the addition of PAOs, Phosphate Accumulating Organisms to the media the population in a reactor can be boosted quickly.

Reduced nitrogen—The present invention advantageously reduces the need for additives for the elimination of nitrogenous compounds from the wastewater. Heretofore, operators needed to add carbon sources such as glycerin or methanol to wastewater to promote the removal of the nitrogen compounds from the wastewater, when the lignocellulosic media breaks down over time it releases carbon needed for denitrification eliminating or reducing the need for additional carbon.

Reduced oxygenation—Another way the present invention is advantageous is through reduced requirement for dissolved oxygen, which reduces the oxygenation requirements and thus the energy requirements of the treatment process. A reduced oxygenation requirement reduces operational energy costs.

Greenhouse gases—Yet another way the present invention is advantageous is through the reduction of greenhouse gases. By adding a lignocellulosic media to activated sludge mixed liquor and improving the abundance of AOBs, NOBs and Annamox bacteria, nitrous oxide (N2O) emissions can be lowered by promoting larger populations of AOBs, NOBs and Annamox bacteria as a percent of the Mixed Liquor that makes the transactions between the microbes more secure reducing the release of N2O due to partial reactions. The reduction of N2O is an important goal because the global warming potential of N2O is 296 kg equivalent CO2.

“Upon subjecting the nationwide data set to multivariate regression data mining, high nitrite, ammonium, and dissolved oxygen concentrations were positively correlated with N2O emissions from aerobic zones of activated sludge reactors. On the other hand, high nitrite and dissolved oxygen concentrations were positively correlated with N2O emissions from anoxic zones. Based on these results, it can be argued that activated sludge processes that minimize transient or permanent build up of ammonium or nitrite, especially in the presence of dissolved oxygen, are expected to have low N2O emissions.”http://pubs.acs.org/doi/abs/10.1021/es903845y By increasing the population of AOBs, NOBs, and Annamox as a percent of the populations, the presence of more AOB, .NOB, .Annamox. and lower DO significantly reduce the Green House Gas emission of N2O.

By adding a lignocellulosic media to activated sludge mixed liquor we can reduce the amount of CO2 that is created to remove/reduce influent COD. This is evident by following the normal oxygen pathways (the DO pathway).), First, oxygen is pumped in, makes its way to the surface and is released into the atmosphere, unused. Secondly, Oxygen is used by Facultative Heterotrophs to directly convert COD. They “breathe” or consume the oxygen, convert the COD mass to their bodies and exhale CO2 at a rate of 1:1. Thirdly, Oxygen is used by AOBs to convert ammonia to nitrite, NO2. NOBs use oxygen to convert the nitrite to nitrate, NO3 (nitrification). NO3 is used by facultative heterotrophs to convert COD. They “breath” the NO3, convert the COD to body mass and exhale CO2 at a rate of “1.0:0.8”.

By making a system more efficient at nitrification—moving ammonia to Nitrite NO2 and to nitrate NO3—done by having more AOBs and NOBs available as a percentage of the mixed liquor population the oxygen pathway can be adjusted to look more like what is described hereinbelow. The oxygen bound to the NO3 is used to reduce COD during the denitrification phase, the same oxygen unit performs two jobs. Less oxygen is needed less CO2 is produced. Oxygen is pumped in and releases into the atmosphere, unused. Oxygen is used by AOBs to convert ammonia to nitrite, NO2. NOBs use oxygen to convert the nitrite to nitrate, NO3. NO3 is used by facultative heterotrophs to convert COD. They “breathe”or consume the NO3, convert the COD to body mass and exhale CO2 at a rate of “1:8”. Oxygen is used by facultative heterotrophs to directly convert COD. They “breathe” or consume the oxygen, convert the COD mass to their bodies and exhale CO2 at a rate of 1:1. By making a system more efficient at nitrification—moving ammonia to nitrate—done by having more AOBs and NOBs available as a percentage of the mixed liquor population, there is more opportunity to use the oxygen “twice”, once to nitrify and once to denitrify. Less oxygen consumed means less CO2 produced.

By adding a lignocellulosic media to activated sludge mixed liquor systems that are using an external carbon source we can significantly reduce the CO2 emissions from a wastewater treatment plant. Due to nature, and the non-biofilm situation in most activated sludge reactors, systems have to run DO levels “high” to provide enough O2 to “force” nitrification via their limited and spread out populations of AOBs and NOBs. By pumping in this “high” DO, systems provide lots of “easy to get to” DO for the heterotrophs to use to convert COD, they out-compete the AOBs. This often ends up “burning off” COD at the aerobic end of the process leaving no COD for denitrification at the anoxic end. So, systems wind up adding an external carbon source for denitrification because the pick up of O2 for nitrification is so weak. By improving the nitrification of ammonia by nitrifiers, (AOBs and NOBs) due to a higher population and closer proximity than normal, nitrifiers become better competitors for available DO. Systems can run lower levels of DO, allowing them to not “burn off” as much COD during nitrification leaving COD for denitrification in the anoxic zones.

This efficiency does three things: 1) Lower average DO levels saves power to run pumps; 2) It allows the “double use” of O2, see above change in the O2 pathway via nitrification and denitrification; 3) It reduces the amount of external carbon that has to be added into a system. This external carbon is partially converted to CO2 during denitrification.

Additionally, the following reduction in global warming gas emissions result from the present invention: carbon is confined into the bodies of facultative heterotrophs; carbon consumption is reduced due to lower uses of electricity; and carbon consumption is reduced due to reduced use of chemical.

Increasing the population of Annamox Bacteria in Mixed Liquor—By adding a lignocellulosic biofilm media enhanced with AOBs, and/or Annamox, to mixed liquor of an activated sludge treatment plant a circumstance is created that promotes the growth and health of Annamox bacteria. Annamox use Nitrite in their processing of Ammonia. With a more robust and closer population of AOB bacteria converting Ammonia to Nitrate, more Nitrate is available to naturally occurring Annamox to thrive as they attach to the lignocellulosic material and colonized surrounding floc.

Reduction in the reproduction rate/sludge yield of the mixed liquor. It is known that AOBs, NOBs and Annamox reproduce at a slower rate than Heterotrophic microbes. By increasing the population of AOBs, NOBs, and Annamox as a percent of the population the reproduction/sludge yield rate can be seen. Also by leveraging the removal of COD via the Nitrate pathway the yield of sludge is reduced.

Wet weather settling—One huge issue with municipal wastewater operations is the impact of “wet weather” events. For instance, aA plant may normally treat 20 mgd on a dry day, but, it rains hard and they might get flows of 50 mgd. The threat is that their biology, the microbes in their mixed liquor gets “washed out” into the river. So, they loose their ability to treat because their microbes are gone. This represents a real problem in the current commercial applications. By adding a lignocellulosic biofilm media a plant can improve their ability to “run through” wet weather events and not loose their solids (bacteria) (See chart in Figures).

In repeated full scale demonstrations, a lignocellulosic media with a surface area of 7.4 square meters per gram and a COD value of 1.17 mg/mg has been used to retrofit existing activated sludge systems, upgrading them to biofilm reactors with an “external/internal” carbon source. Plants with capacity from 0.085 mgd to 32 mgd and no physical modifications are able to consistently nitrify and denitrify using lower average DOs, with zero or reduced outside carbon feeds.

### EXAMPLE 1

### Mebane N.C. “Fines” (Small, Fine Particles in MLSS) that were not able to be Settled in Mebane's Clarifiers and was Ending Up in their Sand Filters, Clogging them Up

### Primary Goal:

Improving Settling in Clarifiers so the sand filters would not clog up.

### Current Goals:

Consistent denitrification; consistent phosphorous removal; eliminate need for settling polymers.

### Dosage:

Original based on settling and Total Suspended Solids Goals. % of Mixed Liquor.

### Current Dosing:

since Fall of 2011 based on biofilm modeling taking into consideration, solids retention time, influent ammonia, influent COD and flux rate per m2 of media of 0.1125. Using 7.4 M2/gram kenaf powder.

### FISH:

Fluorescent in situ hybridization samples were taken March, June, December 2011 and February 2012 for probes: Ammonia Oxidizing Bacteria (AOBs); Nitrite Oxidizing Bacteria (NOBs); and Annamox bacteria.

### Results:

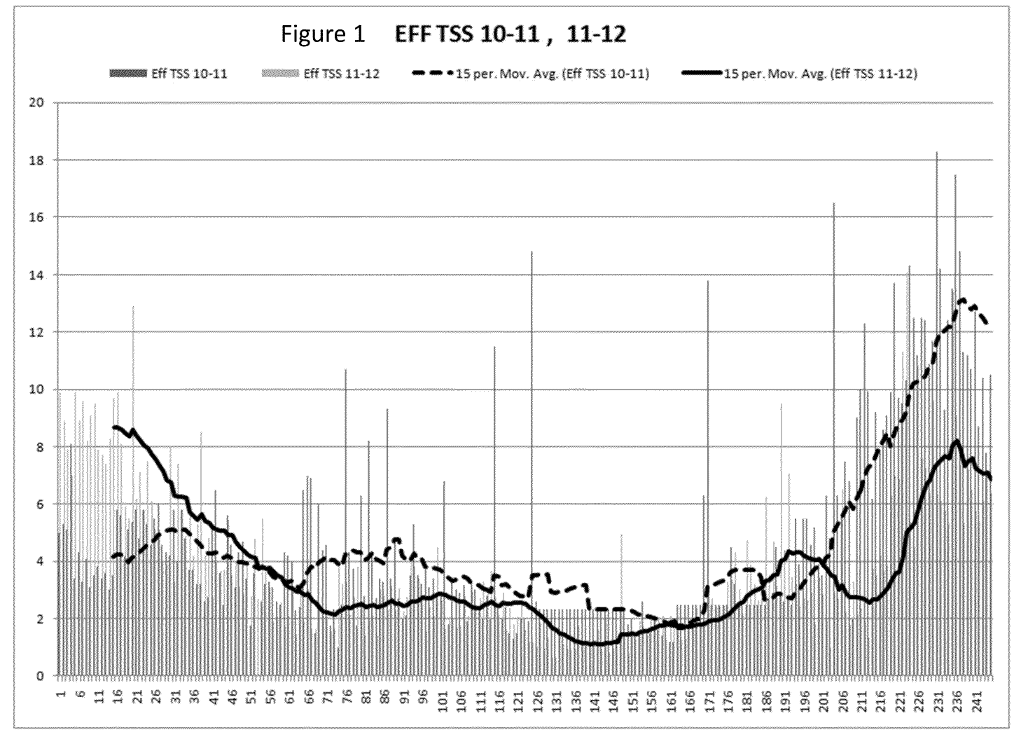

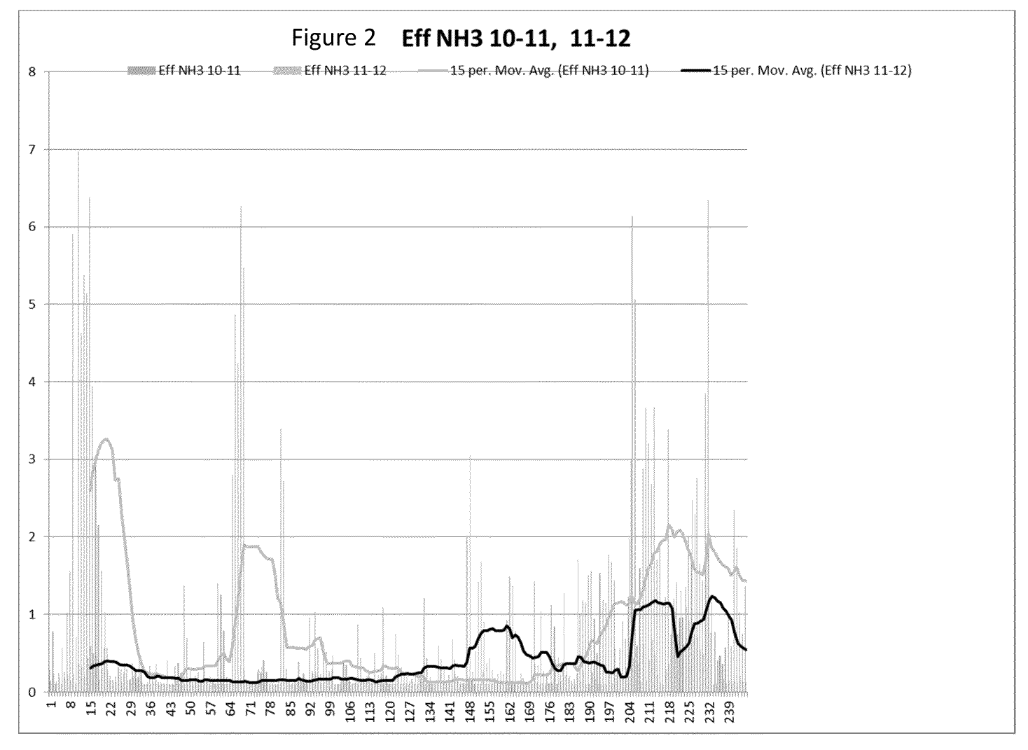

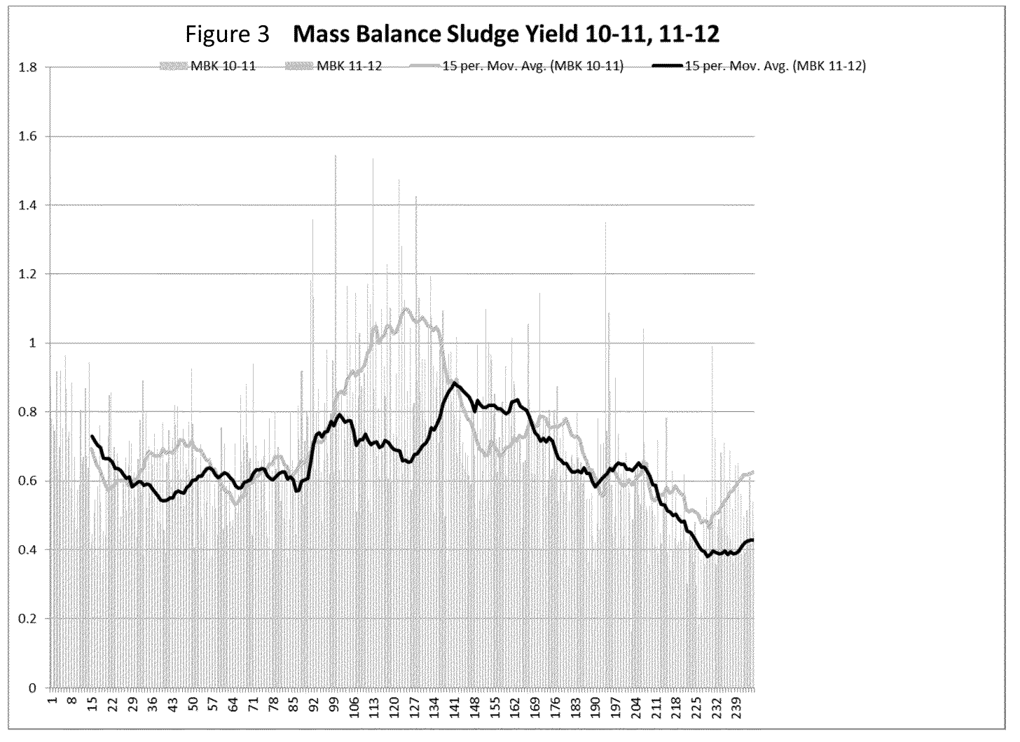

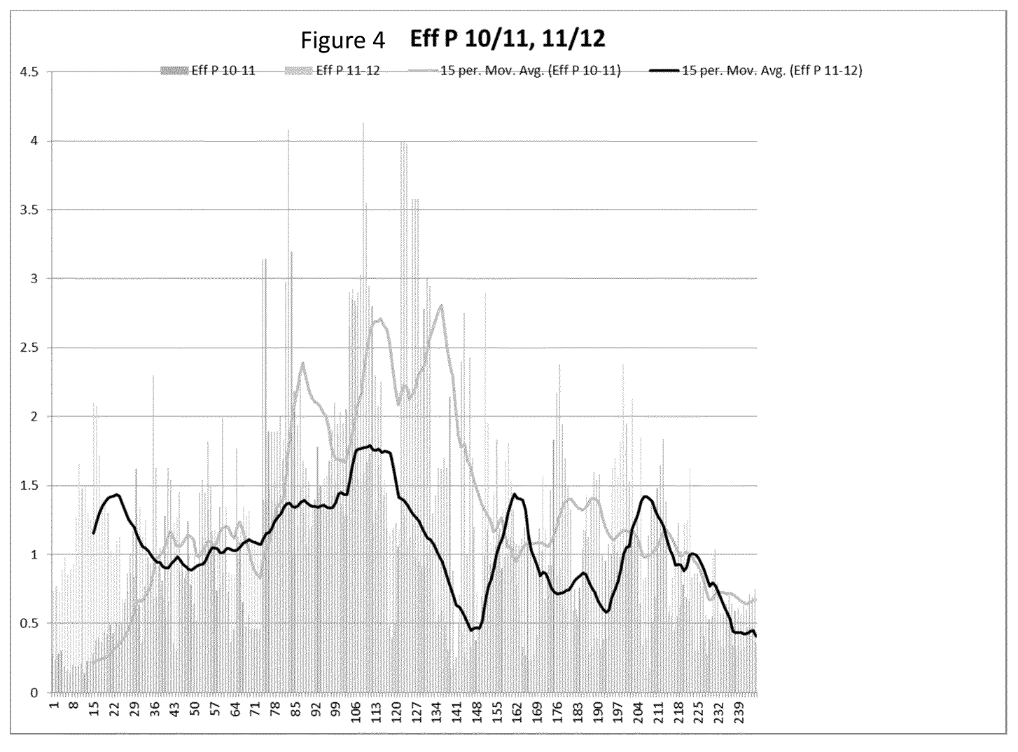

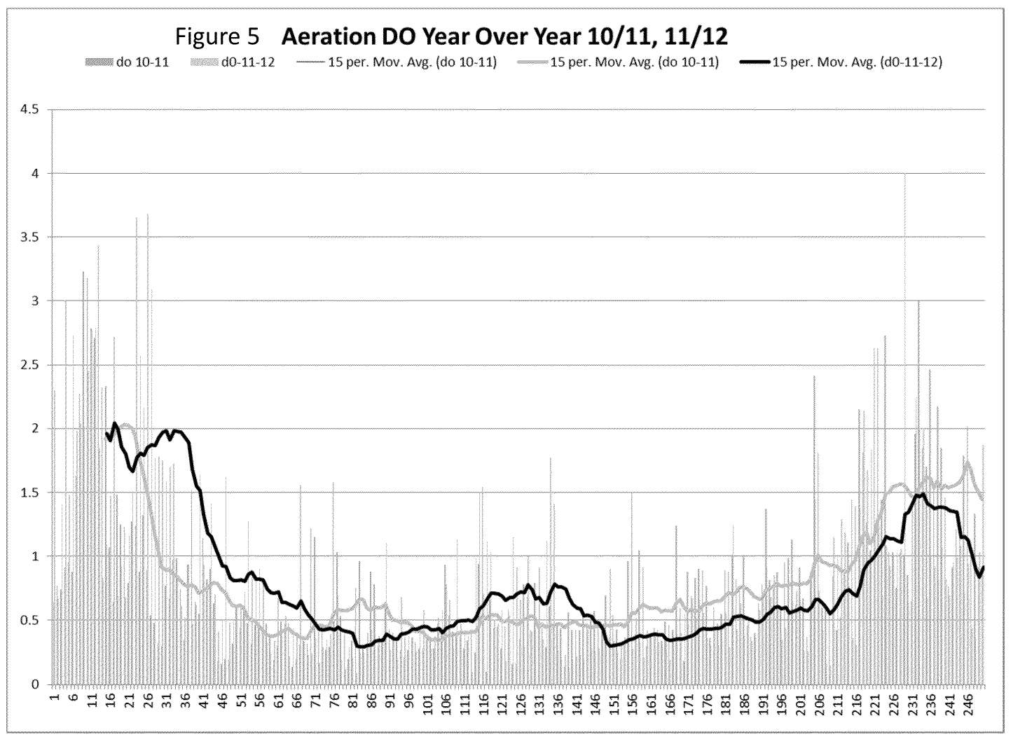

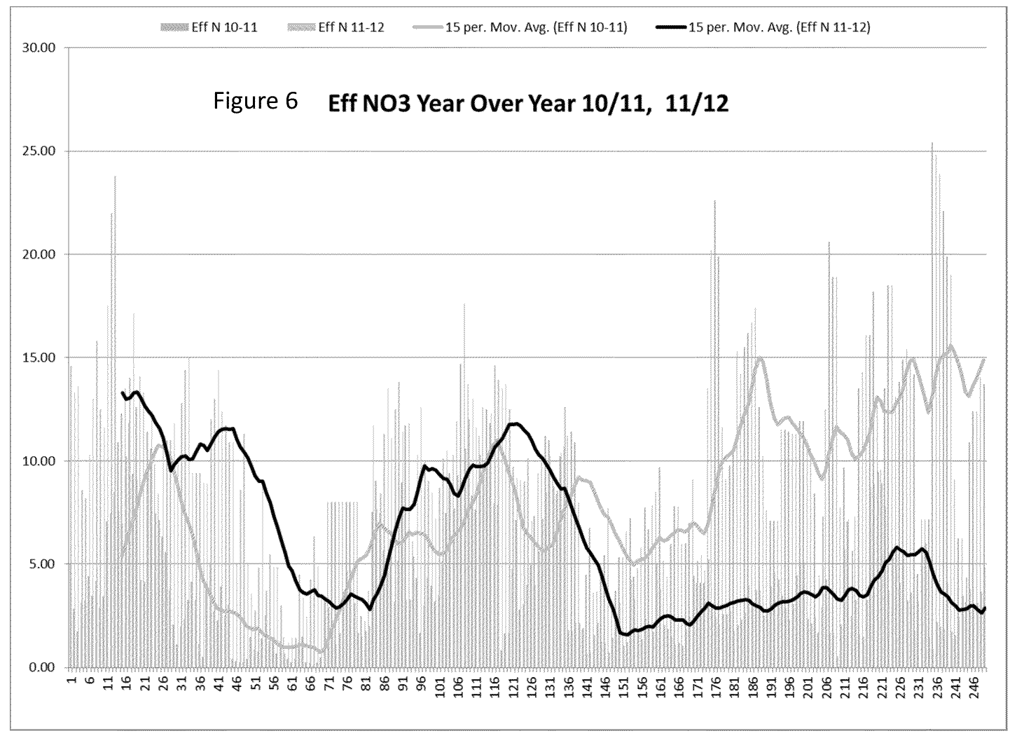

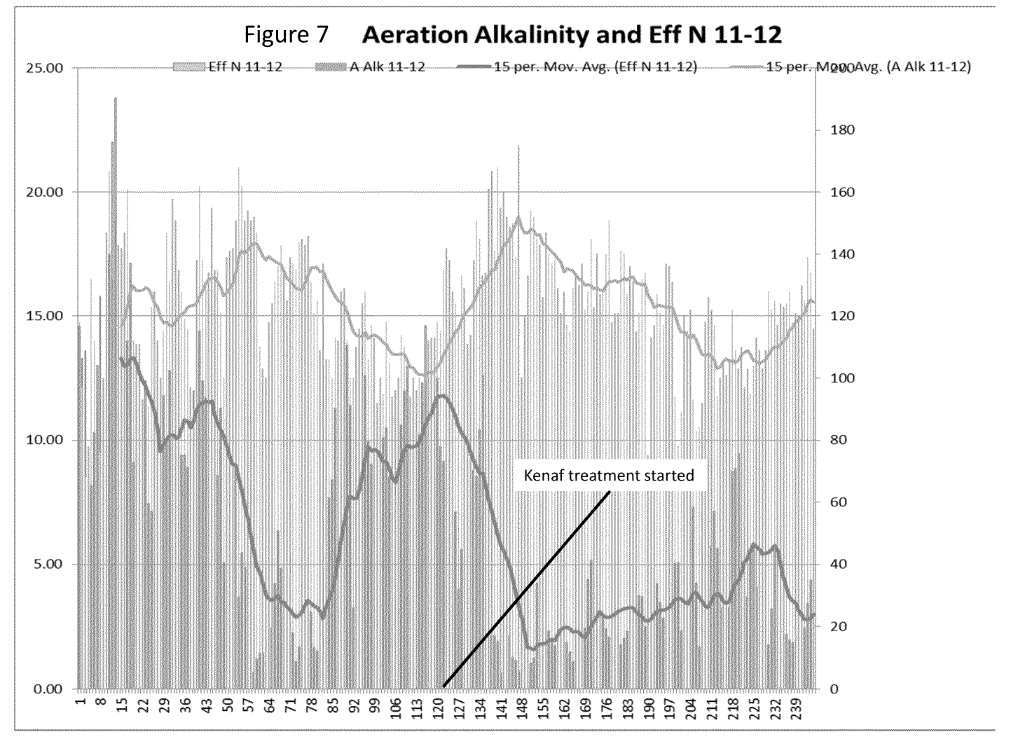

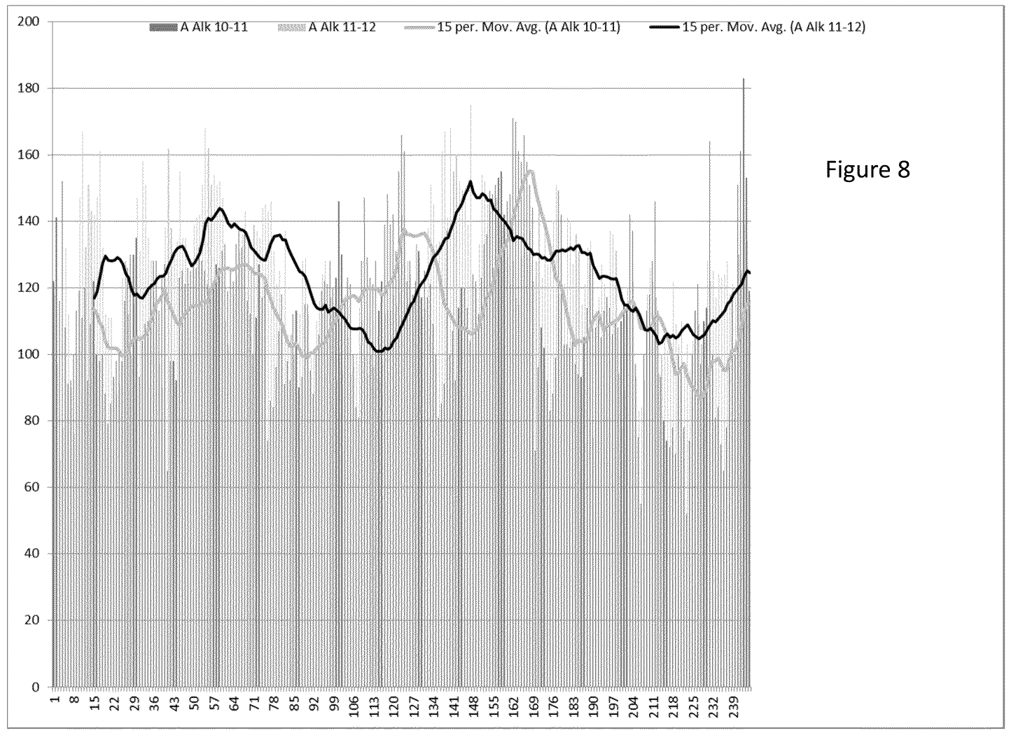

Better settling in clarifiers as measured by less effluent TSS (FIG. 1) and less usage of polymers for coagulation. Better ammonia nitrogen removal control measured by effluent results (FIG. 2). Lower sludge growth yield year over year computed via mass balance methodology (FIG. 3). Better Bio P performance measured by reduction of alum usage for CPR and better more consistently low effluent results (FIG. 4). Reduction in the amount DO levels (FIG. 5) that had to be carried to nitrify and denitrify ammonia resulting in reductions of electricity that needed to be used between 15% and 20%—down to 108 hours from 132 total blower hours per day. In addition, reductions were also seen in the effluent NO3 (FIG. 6), effluent Nitrogen (FIG. 7) and Aeration Alkalinity (FIG. 8).

### FISH Results:

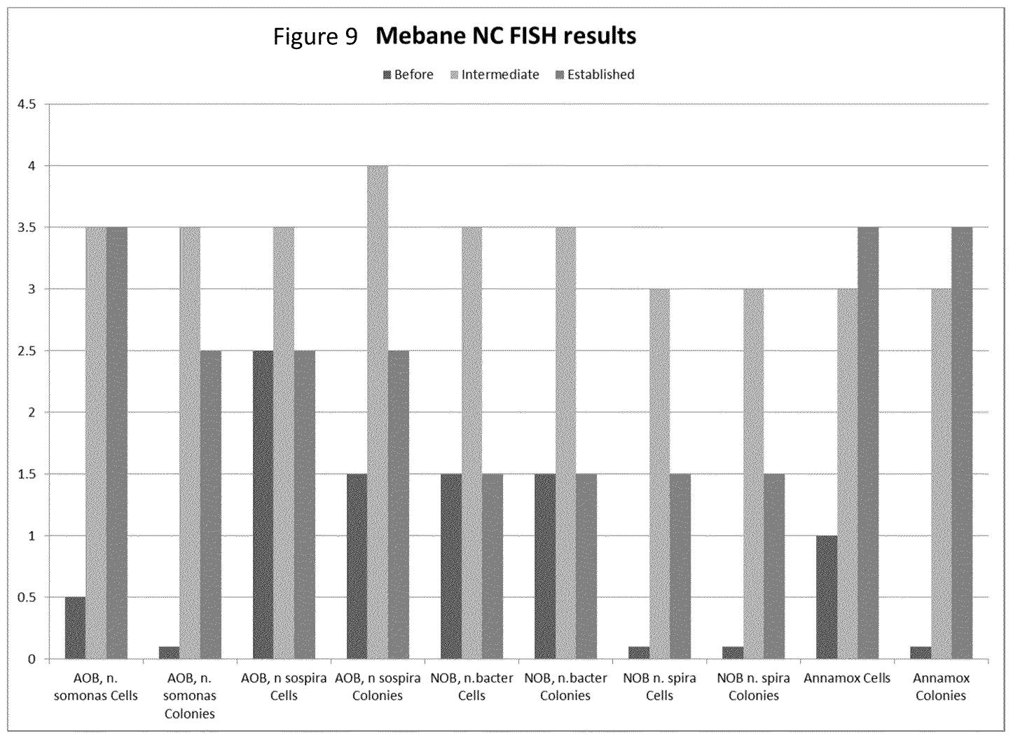

Persistent increases were observed on all AOBs, NOBs and Annamox from base line levels (FIG. 9).

### EXAMPLE 2

### Lenoir N.C. A 2.5 mgd Wastewater Treatment Plant

### Primary Goal:

Sludge Reduction via K value. Measured by Mass Balance.

### Dosage:

Based on settling and total suspended solids goals. % of mixed liquor.

### FISH:

Fluorescent In situ Hybridization samples were taken for probes: Ammonia Oxidizing Bacteria (AOBs) Nitrite Oxidizing Bacteria (NOBs) and Annamox Bacteria.

### Results:

We were not able to perform Sludge Yield Mass balance mathematical analysis due to poor influent COD/BOD record keeping numbers. Better settling in clarifiers measured by less effluent TSS and less usage of polymers for coagulation.

### FISH Results:

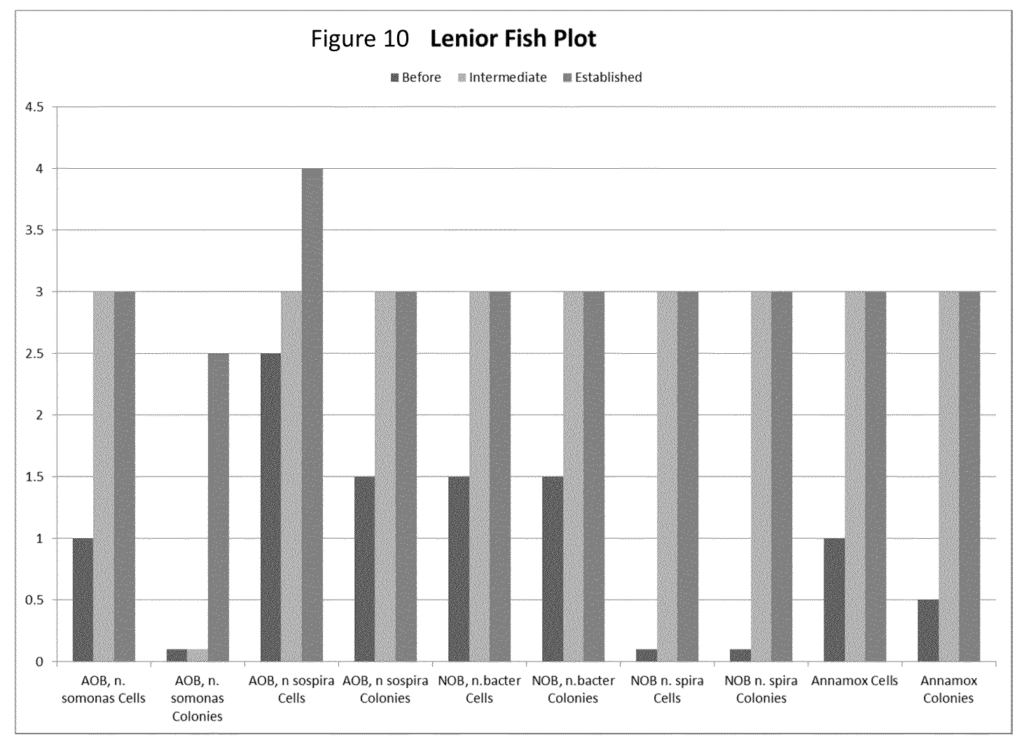

More Annamox, more AOBs more NOBs (FIG. 10). VIA FISH saw significant changes in microbial population especially the growth of Annamox. We were able to track the presence of Annamox prior to media usage, we watched NOBs populations increase then saw Annamox populations increase while competing NOB populations decreased.

### EXAMPLE 3

### Roanoke Va. Train A, an 8 mgd of a 32 mgd Wastewater Treatment Plant

### Primary Goal:

wet weather settling. Sludge reduction.

### Dosage:

Based on settling and total suspended solids goals. 8% of mixed liquor overlapped with ammonia biofilm modeling and SRT.

### FISH:

Fluorescent In situ Hybridization samples were taken and probed for Ammonia Oxidizing Bacteria (AOBs) Nitrite Oxidizing Bacteria (NOBs) and Annamox Bacteria

### Results:

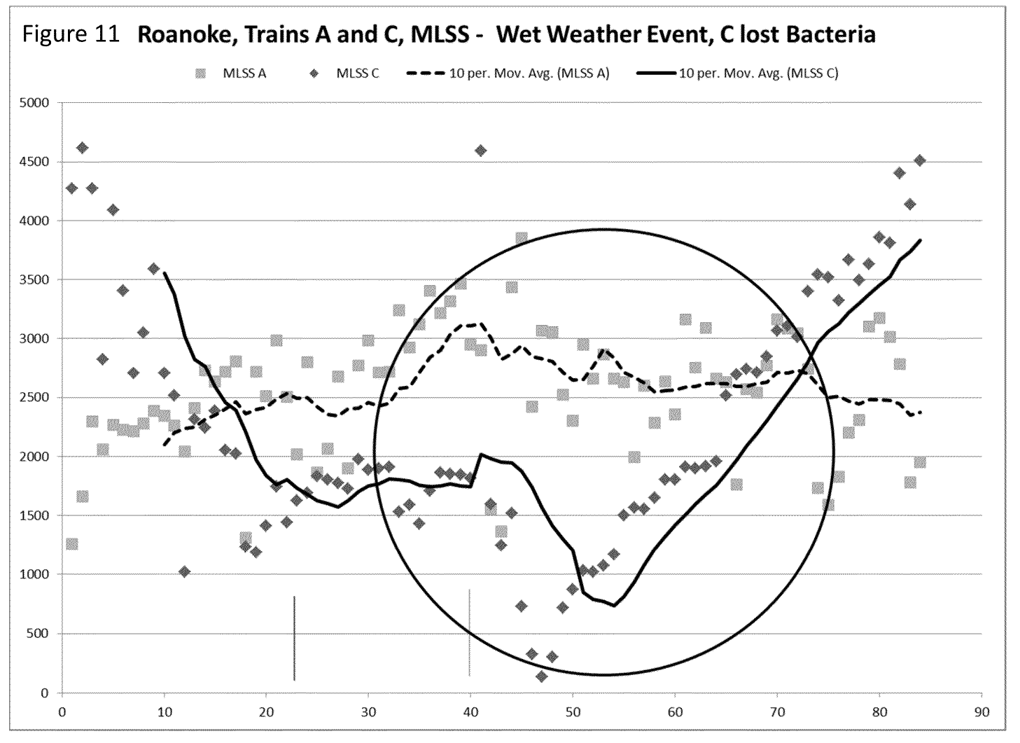

Wet weather settling—Hurricane Irene washed out Train C, our comparison train, Train A held solids. Measured by reported MLSS in the trains (FIG. 11). Train C had to be rebuilt.

Settling. 8 mgd Train A ran on 10 Clarifiers, with the media and established growth train was able to be settled in 6 clarifiers.

Compared to the control Train C, Train A had lower effluent Phosphorous.

Compared to the control Train C, Train A had lower sludge yields based on Mass Balance analysis.

When the lignocellulosic media was started Train A had filamentous bacteria, after 3 weeks this filamentous infestation disappeared. It is believed to be due to the improved carbon loading from the media, there was more COD food available to the floc improving the f/m ratio, and the filamentous bacteria were eliminated.

### FISH:

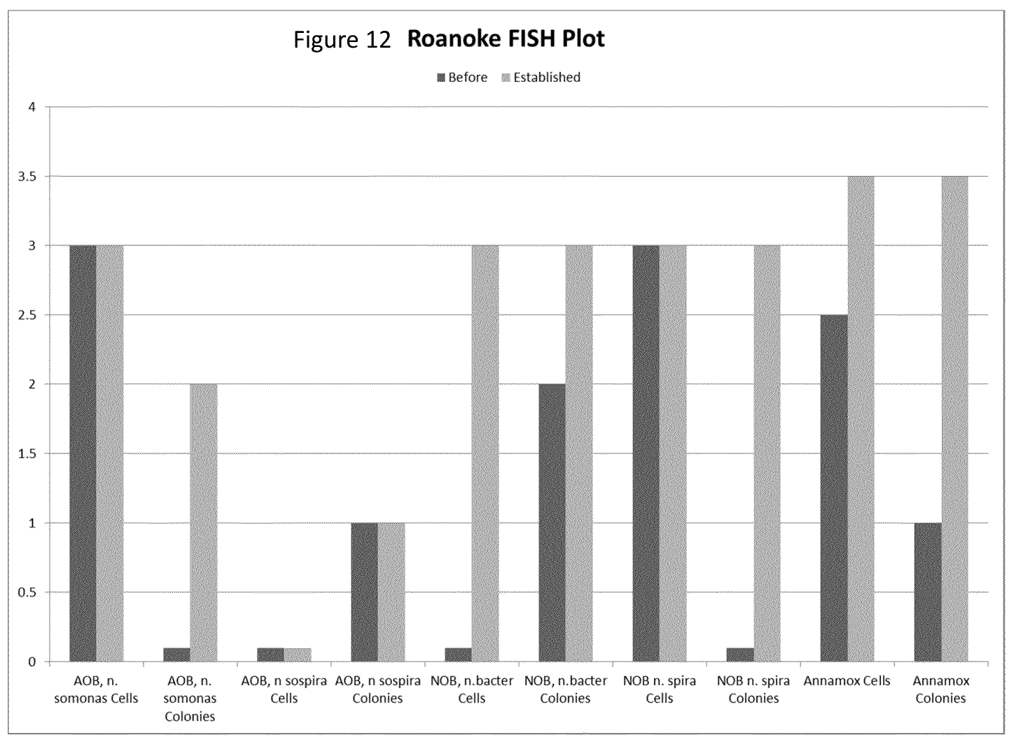

AOB, NOB and Annamox increased (FIG. 12).

### EXAMPLE 4

### Tincastle Va.; a 0.5 mgd Wastewater Treatment Plant

### Primary Goal:

Replacement of Alum for settling in clarifiers.

### Dosage:

Based on settling and Total Suspended Solids Goals. 6% of Mixed Liquor Solids replaced and replenished

### FISH:

NONE.

### Results:

Tyncastle able to turn off alum feed for settling. Operators report better than normal clarifier clarity.

### EXAMPLE 5

### Henrico Va. A 32 mgd Wastewater Treatment Plant. Glucose addition at 65 Gallons Per Hour

### Primary Goal:

Wet weather settling.

### Secondary Goal:

Glucose replacement, reduction of reactor volume in service, reduction of clarifiers in service

### Dosage:

Based on influent Ammonia, Surface area Flux Rate, SRT and Lignocellulosic Breakdown. Flux rate of 0.1125 per square meter assumed and breakdown rate of 22 days

### FISH:

Fluorescent In situ Hybridization samples were taken January 3rd and February 5th. for Probes: Ammonia Oxidizing Bacteria (AOBs) Nitrite Oxidizing Bacteria (NOBs) and Annamox Bacteria. No change results back from lab yet.

### Results:

Reduced the glucose feed from 65 gph to 43 gph. Due to use of carbon release from media break down. Clarifiers looked “better”, thus indicating improved clarification of the wastewater. Lab reports more VFAs in Anaerobic Digesters.

### EXAMPLE 6

### Greensboro, N.C. T Z Ozborne; a 23 mgd Wastewater Treatment Plant

### Primary Goal:

Reduction of Electricity by lowering overall DO in basins.

### Secondary Goals:

Wet weather settling; sludge yield reductions.

### Dosage:

Based on influent Ammonia, Surface area Flux Rate, SRT and Lignocellulosic Breakdown. Flux rate of 0.1125 assumed and breakdown of 22 days.

### FISH:

Fluorescent In situ Hybridization samples were taken May, July August for Probes: Ammonia Oxidizing Bacteria (AOBs) Nitrite Oxidizing Bacteria (NOBs) and Annamox Bacteria.

### Results:

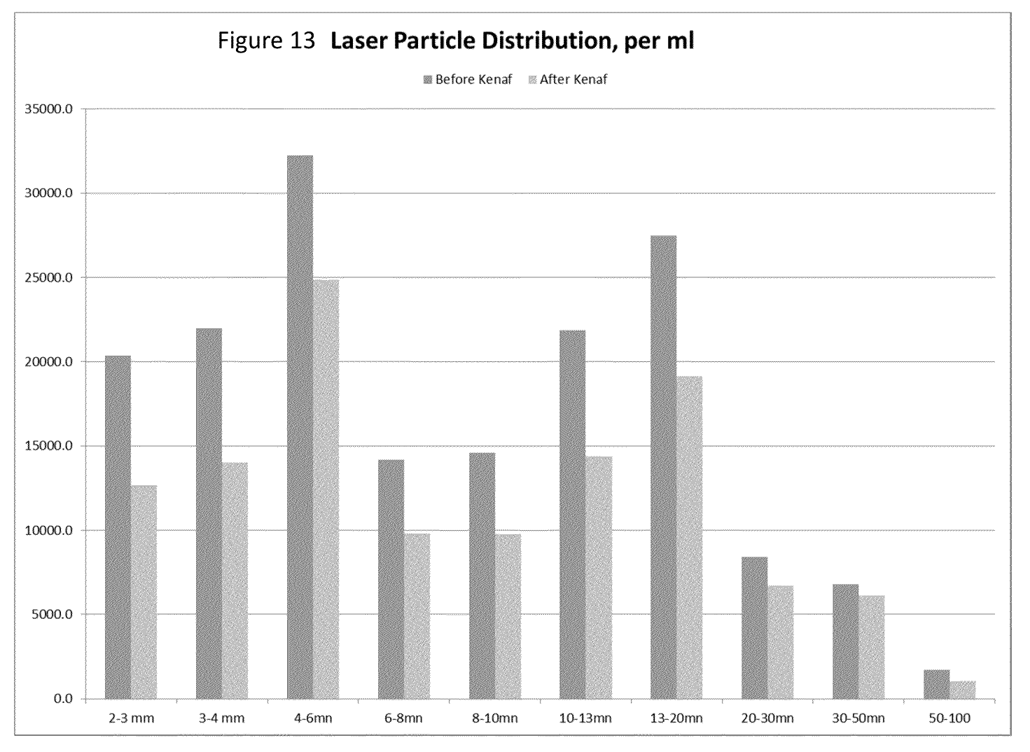

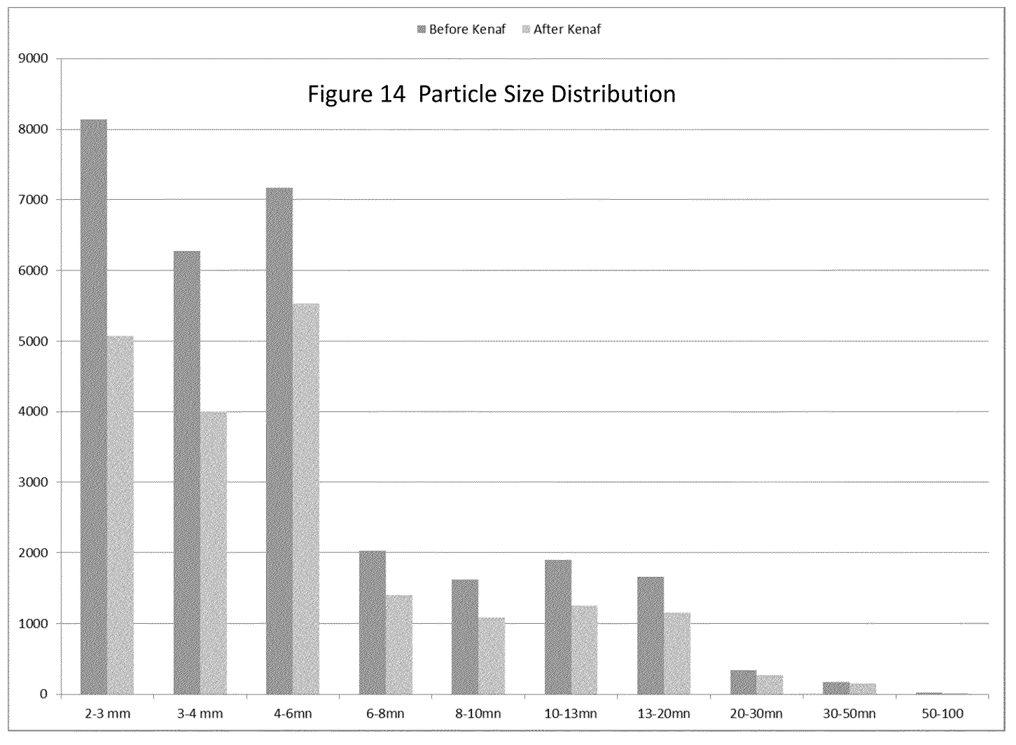

Filter company NOVA, who was running a clarifier effluent filter test while media was being added reports lower particulate numbers reaching their testing equipment with media in the system The treatment reduced the particle numbers and increased the particle size, as shown in FIGS. 13 and 14, respectively. Plant reports low effluent P numbers and that they have gone from running 2 tankers of Alum per week for Chemical Phosphorous Removal to one.

### EXAMPLE 7

### Woodbridge, Va. PWCSA, HL Mooney Plant; a 4 mgd train 3 of 16 mgd Total Wastewater Treatment Plant. Methanol is Added as a Carbon Addition

### Primary Goal:

Reduction of Electricity by lowering overall DO in basins and reduction of Methanol usage as carbon source.

### Secondary Goals:

Reduction of Electricity by lowering overall DO in basins; wet weather settling; sludge yield reductions.

### Dosage:

Based on influent Ammonia, Surface area Flux Rate, SRT and Lignocellulosic Breakdown. Flux rate of 0.1225 per square meter surface area and 22 day breakdown.

### FISH:

Fluorescent In situ Hybridization samples were taken January 222 and February 22nd. Probes: Ammonia Oxidizing Bacteria (AOBs) Nitrite Oxidizing Bacteria (NOBs) and Annamox Bacteria. Still waiting for February 22 results to come back.

### Results:

Upon seeing growth of biofilm on media, plant has decided to reduce Methanol feed by 100 gallons per day to Train 3, down from 200 gallons per day.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A method for treating wastewater comprising the steps of:
a. providing an effector composition including lignocellulosic particles with at least one absorbed microorganism species therein;
b. mixing the effector composition with the wastewater;
c. oxygenation the wastewater;
d. reacting the wastewater;
e. clarifying the wastewater;
thereby reducing the carbon, phosphorous and nitrogenous compounds in the wastewater.

2. The method of claim 1, further including the step of absorbing the at least one microorganism species into internal spaces of the lignocellulosic particles.

3. The method of claim 1, wherein the lignocellulosic particles are mixed with the influent wastewater based on flux rates, biofilm loading formulas and lignocellulo sic degradating rates.

4. The method of claim 1, further including the step of maintaining the dissolved oxygen level of the reactor wastewater to promote the growth and health of AOBs, NOBs, Annamox and PAOs.

5. The method of claim 1, further including the step of maintaining the Alkalinity level of the reactor wastewater to promote the growth and health of AOBs, NOBs, Annamox and PAOs.

6. The method of claim 1, wherein the lignocellulosic particles include powered kenaf particles.

7. The method of claim 1, wherein the lignocellulosic particles consist substantially of kenaf particles.

8. A system for treating wastewater comprising: an effector composition including lignocellulosic particles with at least one absorbed microorganism species therein.

9. The system of claim 8, wherein the lignocellulosic particles include powdered kenaf particles.

10. The system of claim 8, wherein the lignocellulosic particles consist substantially of kenaf particles.

11. A method for treating wastewater, the method steps comprising:
a. mixing water with a lignocellulosic particulate to form an effector composition;
b. mixing the effector composition with the wastewater;
c. oxygenating the wastewater;
d. reacting the wastewater;
e. clarifying the wastewater;
thereby reducing the carbon, phosphorous and nitrogenous compounds in the wastewater.

12. The method of claim 10, wherein the lignocellulosic particulate includes kenaf particulate.

13. The method of claim 10, wherein the lignocellulosic particles are mixed with the influent wastewater based on flux rates, biofilm loading formulas and lignocellulo sic degradating rates for optimizing wastewater clarification.

14. The method of claim 1, wherein the lignocellulosic particles are mixed with the influent wastewater based on flux rates, biofilm loading formulas and lignocellulo sic degradating rates.

15. The method of claim 1, further including the step of maintaining the dissolved oxygen level of the reactor wastewater to promote the growth and health of AOBs, NOBs, Annamox and PAOs.

16. The method of claim 1, further including the step of maintaining the Alkalinity level of the reactor wastewater to promote the growth and health of AOBs, NOBs, Annamox and PAOs.
